(19) United States
(12) Patent Application Publication
(10) Pub. No.: US 2004/0216003 A1
(43) Pub. Date: Oct. 28, 2004

(54) Mechanism for FRU fault isolation in distributed nodal environment

(75) Inventors: Michael Stephen Floyd, Austin, TX (US); Larry Scott Leitner, Austin, TX (US); Kevin Franklin Reick, Round Rock, TX (US)

Correspondence Address: Jack V. Musgrove, 2911 Briona Wood Lane, Cedar Park, TX, 78613, US

(73) Assignee: INTERNATIONAL BUSINESS MACHINES CORPORATION, ARMONK, NY

(21) Appl. No.: 10/425,441

(22) Filed: Apr. 28, 2003

(51) Int. Cl. H02H 3/05

(52) U.S. Cl. 714/25

(57) ABSTRACT

A method of identifying a primary source of an error which propagates through a computer system and generates secondary errors, by initializing a plurality of counters that are respectively associated with the computer components (e.g., processing units), incrementing the counters as the computer components operate but suspending a given counter when its associated computer component detects an error, and then determining which of the counters contains a lowest count value. The counters are synchronized based on relative delays in receiving an initialization signal. When an error is reported, diagnostics code logs an error event for the particular computer component associated with the counter containing the lowest count value.

### BACKGROUND OF THE INVENTION

1. Field of the Invention

The present invention generally relates to computer systems, and more specifically to an improved method of determining the source of a system error which might have arisen from any one of a number of components, particularly field replaceable units such as processing units, memory devices, etc., which are interconnected in a complex communications topology.

2. Description of the Related Art

The basic structure of a conventional symmetric multi-processor computer system 10 is shown in FIG. 1. Computer system 10 has one or more processing units arranged in one or more processor groups; in the depicted system, there are four processing units 12a, 12b, 12c and 12d in processor group 14. The processing units communicate with other components of system 10 via a system or fabric bus 16. Fabric bus 16 is connected to one or more service processors 18a, 18b, a system memory device 20, and various peripheral devices 22. A processor bridge 24 can optionally be used to interconnect additional processor groups. System 10 may also include firmware (not shown) which stores the system's basic input/output logic, and seeks out and loads an operating system from one of the peripherals whenever the computer system is first turned on (booted).

System memory device 20 (random access memory or RAM) stores program instructions and operand data used by the processing units, in a volatile (temporary) state. Peripherals 22 may be connected to fabric bus 16 via, e.g., a peripheral component interconnect (PCI) local bus using a PCI host bridge. A PCI bridge provides a low latency path through which processing units 12a, 12b, 12c and 12d may access PCI devices mapped anywhere within bus memory or I/O address spaces. PCI host bridge 22 also provides a high bandwidth path to allow the PCI devices to access RAM 20. Such PCI devices may include a network adapter, a small computer system interface (SCSI) adapter providing interconnection to a permanent storage device (i.e., a hard disk), and an expansion bus bridge such as an industry standard architecture (ISA) expansion bus for connection to input/output (I/O) devices including a keyboard, a graphics adapter connected to a display device, and a graphical pointing device (mouse) for use with the display device.

In a symmetric multi-processor (SMP) computer, all of the processing units 12a, 12b, 12c and 12d are generally identical, that is, they all use a common set or subset of instructions and protocols to operate, and generally have the same architecture. As shown with processing unit 12a, each processing unit may include one or more processor cores 26a, 26b which carry out program instructions in order to operate the computer. An exemplary processor core includes the PowerPC™ processor marketed by International Business Machines Corp. which comprises a single integrated circuit superscalar microprocessor having various execution units, registers, buffers, memories, and other functional units, which are all formed by integrated circuitry. The processor cores may operate according to reduced instruction set computing (RISC) techniques, and may employ both pipelining and out-of-order execution of instructions to further improve the performance of the superscalar architecture.

Each processor core 12a, 12b includes an on-board (L1) cache (actually, separate instruction cache and data caches) implemented using high speed memory devices. Caches are commonly used to temporarily store values that might be repeatedly accessed by a processor, in order to speed up processing by avoiding the longer step of loading the values from system memory 20. A processing unit can include another cache, such as a second level (L2) cache 28 which, along with a memory controller 30, supports both of the L1 caches that are respectively part of cores 26a and 26b. Additional cache levels may be provided, such as an L3 cache 32 which is accessible via fabric bus 16. Each cache level, from highest (L1) to lowest (L3) can successively store more information, but at a longer access penalty. For example, the on-board L1 caches in the processor cores might have a storage capacity of 128 kilobytes of memory, L2 cache 28 might have a storage capacity of 512 kilobytes, and L3 cache 32 might have a storage capacity of 2 megabytes. To facilitate repair/replacement of defective processing unit components, each processing unit 12a, 12b, 12c, 12d may be constructed in the form of a replaceable circuit board, pluggable module, or similar field replaceable unit (FRU), which can be easily swapped installed in or swapped out of system 10 in a modular fashion.

As multi-processor computer systems increase in size and complexity, there has been an increased emphasis on diagnosis and correction of errors that arise from the various system components. While some errors can be corrected by error correction code (ECC) logic embedded in these components, there is still a need to determine the cause of these errors since the correction codes are limited in the number of errors they can both correct and detect. Generally, ECC codes used are SEC/DED type (Single Error Correct/Double Error Detect). Hence, when a persistent correctable error occurs it is desirable to call for FRU replacement of the defective component as soon as possible to avoid a second error from creating an uncorrectable error and causing the system to crash. When the system has an fault or defect that causes a system error, it can be difficult to determine the original source of the primary error since the corruption can cause secondary errors to occur downstream on other chips or devices connected to the SMP fabric. This corruption can take the form of either recoverable or checkstop (system fault) conditions. Many errors are allowed to propagate due to performance issues. In-line error correction can introduce a significant delay into the system, so ECC might be used only at the final destination of a data packet (the data “consumer”) rather than at its source or at an intermediate node. Accordingly, for a recoverable error, there often lacks sufficient time to ECC correct before forwarding the data without adding undesirable latency to the system, so bad data may intentionally be propagated to subsequent nodes or chips. For both recoverable and checkstop errors, it is important for diagnostics firmware to be able to analyze the system and determine with certainty the primary source of the error, so appropriate action can be taken. Corrective actions may include preventative repair of a component, deconfiguration of selected resources, and/or a service call for replacement of the defective component if it is an FRU that can be swapped out with a fully operational unit.

For system 10, the method used to isolate the original cause of the error utilizes a plurality of counters or timers, one located in each component, and communication links that form a loop through the components. For example, the communications topology for the processors of system 10 is shown in FIG. 2. A plurality of data pathways or buses 34 allow communications between adjacent processor cores in the topology. Each processor core is assigned a unique processor identification number. In one embodiment, one processor core is designated as the primary module, in this case core 26a. This primary module has a communications bus 34 that feeds information to one of the processor cores in processing unit 12b. Communications bus 34 may comprise data bits, controls bits, and an error bit. In this prior art design, each counter in a given processor core starts incrementing when an error is first detected and, after the system error indication has traversed the entire bus topology (via the error bit in bus 34) and returned to that given core, the counters stop. The counters can then be examined to identify the component with the largest count, indicating the primary source of the error.

While this approach to fault isolation is feasible with a simple ring (single-loop) topology, it is not viable for more complicated processing unit constructions which might have, for example, multiple loops criss-crossing in the communications topology. In such constructions, there is no guarantee that the counter with the largest count corresponds to the defective component, since the error may propagate through the topology in an unpredictable fashion determined by exactly which chip experiences the primary error and how the particular data or command packet is being routed along the fabric topology. Although a fault isolation system might be devised having a central control point which could monitor the components to make the determination, the trend in modern computing is moving away from such centralized control since it presents a single failure point that can cause a system-wide shutdown. It would, therefore, be desirable to devise an improved method of isolating faults in a computer system having a complicated communications topology, to pinpoint the source of a system error from among numerous components. It would be further advantageous if the method could utilize existing pathways between the components rather than further complicate the chip wiring with additional interconnections.

### SUMMARY OF THE INVENTION

It is therefore one object of the present invention to provide an improved diagnostic method for a computer system to identify the source of an error.

It is another object of the present invention to provide such a method which can be applied to computer systems having components, such as processor cores, with topologically complex communications paths.

It is yet another object of the present invention to provide a method and system of locating the primary source of an error which might be propagated to other computer components and generate secondary errors in those components.

The foregoing objects are achieved in a method of identifying a primary source of an error which propagates through a portion of a computer system and generates secondary errors, generally comprising the steps of initializing a plurality of counters that are respectively associated with computer components (e.g., processing units), incrementing the counters as the computer components operate but suspending a given counter when its associated computer component detects an error, and then determining which of the counters contains a lowest count value. That counter corresponds to the computer component which is the primary source of the error. The counters are synchronized based on relative delays in receiving an initialization signal. A given counter may be suspended as a result of detection of an error in a component that is on the same integrated circuit chip as that counter, or detection of an error signal from a different integrated circuit chip. When an error is reported, diagnostics code logs an error event for the particular computer component associated with the counter containing the lowest count value.

In order to avoid a potential problem that can arise when a counter wraps a current count around to zero (in a modulo fashion), each counter may be provided with sufficient storage such that a maximum count value for each counter corresponds to a cycle time that is at least two times a maximum error propagation delay around the computer component topology. The diagnostics code then recognizes any low wraparound value and appropriately adds the maximum count value when determining which of the counters has the true lowest count. To further avoid a potential problem with hard faults (i.e., “stuck” bits) that result in recoverable errors, the fault isolation control can quiesce the communications pathways between the computer components and clear fault isolation registers on the computer components, and then restart the communications pathways.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram depicting a conventional symmetric multi-processor (SMP) computer system, with internal details shown for one of the four generally identical processing units;

FIG. 2 is a block diagram illustrating a communications topology for the processors of SMP computer system shown in FIG. 1;

FIG. 3 is a block diagram showing a processor group layout and communications topology according to one implementation of the present invention;

FIG. 4 is a block diagram depicting one of the processing units (chips) in the processor group of FIG. 3, which includes fault isolation circuitry used to determine whether the particular processing unit is a primary source of an error, in accordance with the present invention; and

FIG. 5 is a high-level schematic diagram illustrating one embodiment of fault isolation circuitry according to the present invention.

The use of the same reference symbols in different drawings indicates similar or identical items.

### DESCRIPTION OF THE PREFERRED EMBODIMENT(S)

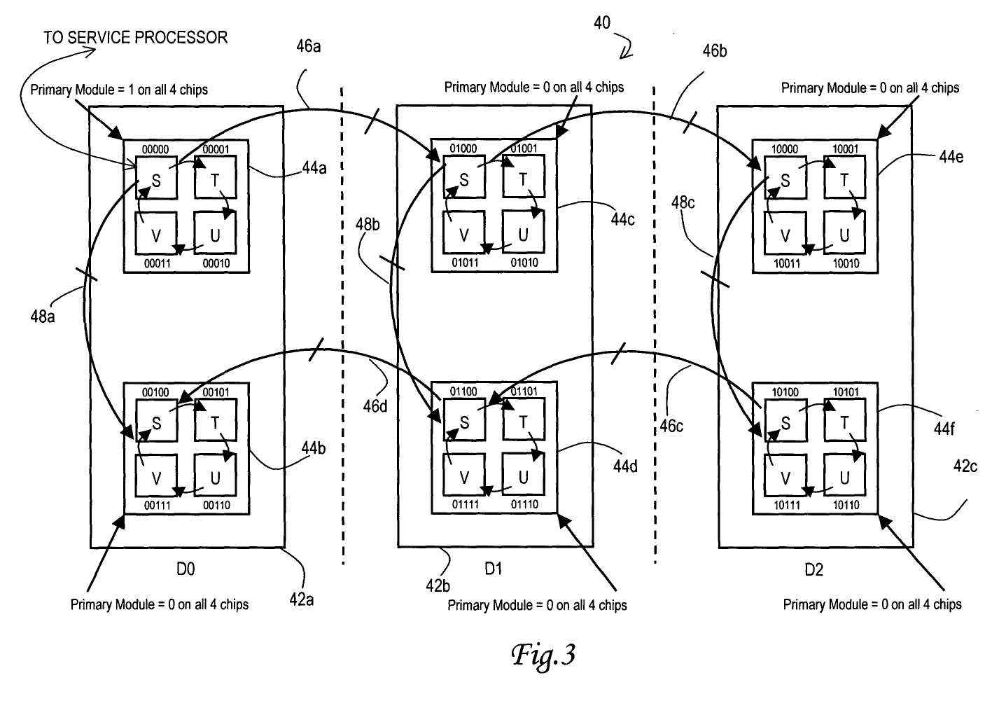

With reference now to the figures, and in particular with reference to FIG. 3, there is depicted one implementation of a processor group 40 for a symmetric multi-processor (SMP) computer system constructed in accordance with the present invention. In this particular implementation, processor group 40 is composed of three drawers 42a, 42b and 42c of processing units. Although only three drawers are shown, the processor group could have fewer or additional drawers. The drawers are mechanically designed to slide into an associated frame for physical installation in the SMP system. Each of the processing unit drawers includes two multi-chip modules (MCMs), i.e., drawer 42a has MCMs 44a and 44b, drawer 42b has MCMs 44c and 44d, and drawer 42c has MCMs 44e and 44f. Again, the construction could include more than two MCMs per drawers. Each MCM in turn has four integrated chips, or individual processing units (more or less than four could be provided). The four processing units for a given MCM are labeled with the letters “S”, “T”, “U”, and “V.” There are accordingly a total of 24 processing units or chips shown in FIG. 3.

Each processing unit is assigned a unique identification number (PID) to enable targeting of transmitted data and commands. One of the MCMs is designated as the primary module, in this case MCM 44a, and the primary chip S of that module is controlled directly by a service processor. Each MCM may be manufactured as a field replaceable unit (FRU) so that, if a particular chip becomes defective, it can be swapped out for a new, functional unit without necessitating replacement of other parts in the module or drawer. Alternatively, the FRU may be the entire drawer (the preferred embodiment) depending on how the technician is trained, how easy the FRU is to replace in the customer environment and the construction of the drawer.

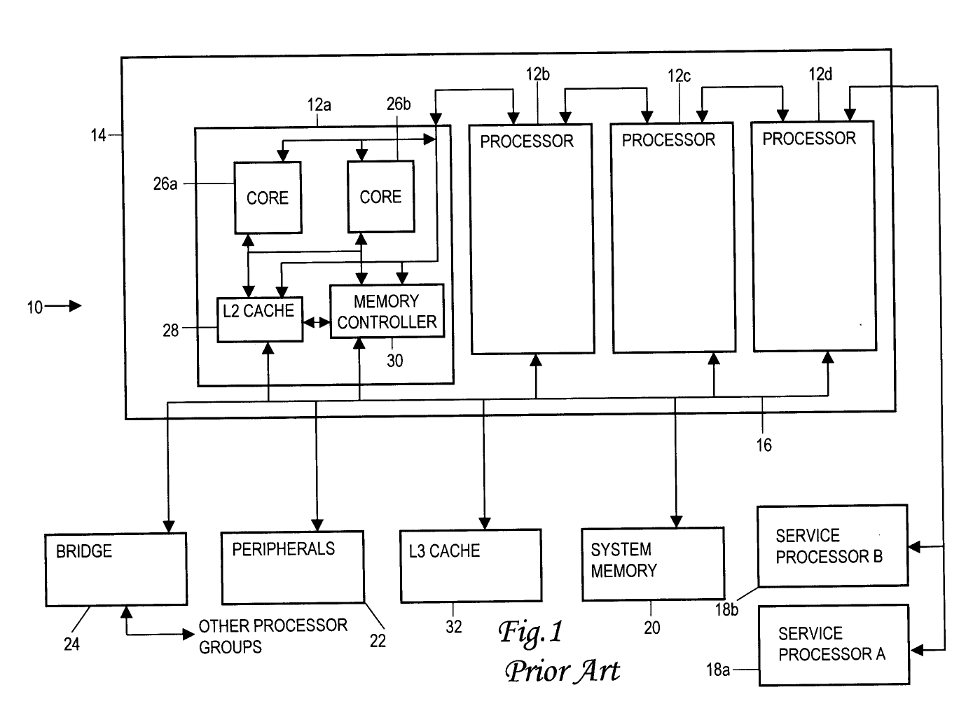

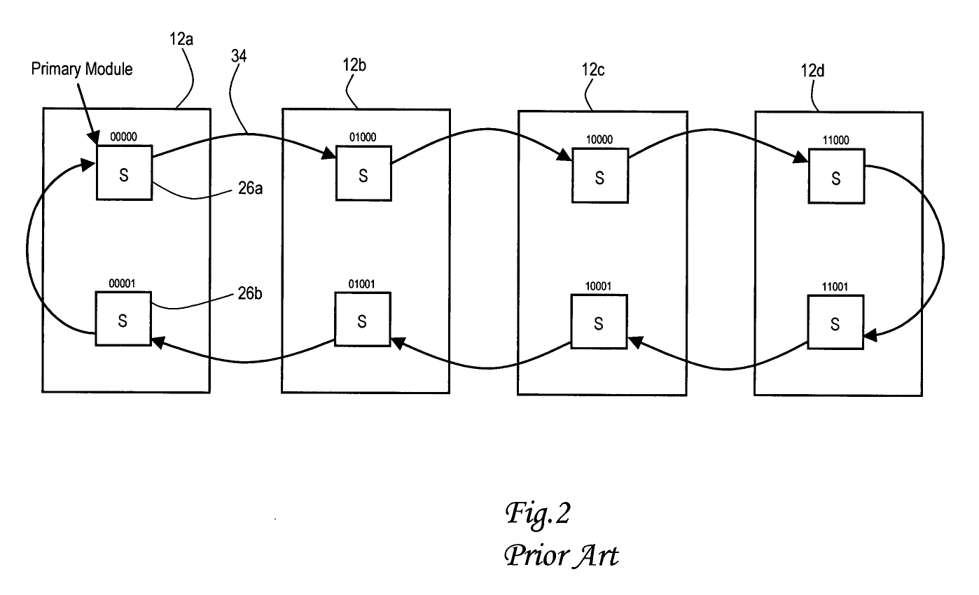

Processor group 40 is adapted for use in an SMP system which may include other components such as additional memory hierarchy, a communications fabric and peripherals, as discussed in conjunction with FIG. 1. The operating system for the SMP computer system is preferably one that allows certain components, viz., FRUs, to be taken off-line while the remainder of the system is running, so that replacement of an FRU can be effectuated without taking the overall system down.

Various data pathways are provided between certain of the chips for performance reasons, in addition to the interconnections available through the communications fabric. As seen in FIG. 3, these paths include several inter-drawer buses 46a, 46b, 46c and 46d, as well as intra-drawer buses 48a, 48b and 48c. There are also intra-module buses which connect a given processing chip to every other processing chip on that same module. In the exemplary embodiment, each of these pathways provides 128 bits of data, 40 control bits, and 1 error bit. Additionally there may be buses connecting a T chip with other T chips, a U chip with other U chips, and a V chip with V chips, similar to the S chip connections 46 and 48 as shown. Those buses were omitted for pictorial clarity. In this particular embodiment, whereas the bus interfaces exist between all these chips include an error signal, the error signal is only actually used on those shown to achieve maximum connectivity and error propagation speed while limiting topological complexity.

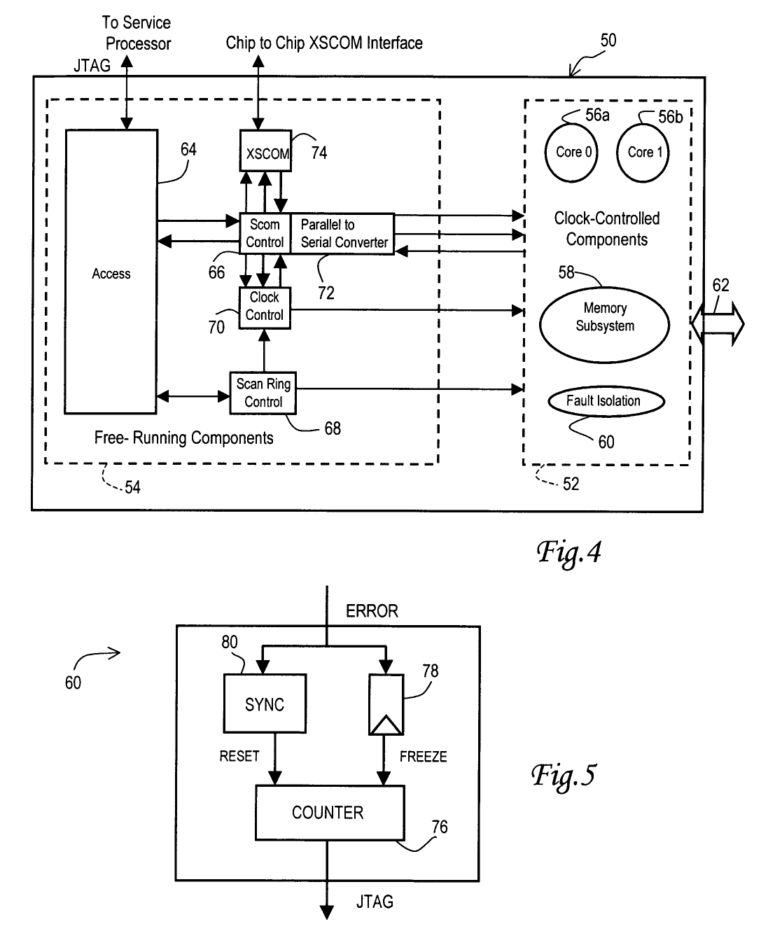

Referring now to FIG. 4, each of the processing units is generally identical, and a given chip 50 is essentially comprised of a plurality of clock-controlled components 52 and free-running components 54. The clock-controlled components include two processor cores 56a and 56b, a memory subsystem 58, and fault isolation circuitry 60. Although two processor cores are shown as included on one integrated chip, there could be fewer or more. Each processor core 56a, 56b has its own control logic, separate sets of execution units, registers, and buffers, and respective first level (L1) caches (separate instruction and data caches in each core). The L1 caches and load/store units in the cores communicate with memory subsystem 58 to read/write data from/to the memory hierarchy. Memory subsystem 58 may include a second level (L2) cache and a memory controller. The processor cores and memory subsystem can communicate with other chips via an interface 62 to the data pathways described in the foregoing paragraph.

The free-running components of chip 50 include a JTAG interface 64 which is connected to a scan communications (SCOM) controller 66 and a scan ring controller 68. JTAG interface 64 provides access between the service processor and internal control interfaces of chip 50. JTAG interface 64 complies with the Institute of Electrical and Electronics Engineers (IEEE) standard 1149.1 pertaining to a test access port and boundary-scan architecture. SCOM is an extension to the JTAG protocol that allows read and write access of internal registers while leaving system clocks running.

SCOM controller 66 is connected to clock controller 70, and to a parallel-to-serial converter 72. SCOM controller 66 allows the service processor to further access “satellites” located in the clock-controlled components while the clocks are still running. These SCOM satellites have internal control and error registers which can be used to enable various functions in the components. SCOM controller 66 may also be connected to an external SCOM (or XSCOM) interface which provides even more chip-to-chip communications without requiring the involvement of the service processor. Additional details of the SCOM satellites and XSCOM chip-to-chip interface can be found in U.S. patent application Ser. No. 10/______ entitled “CROSS-CHIP COMMUNICATION MECHANISM IN DISTRIBUTED NODE TOPOLOGY” (attorney docket number AUS920030211US1) filed contemporaneously herewith, which is hereby incorporated. Scan ring controller 68 provides the normal JTAG scan function (LSSD type) to the internal latch state with functional clocks stopped.

While each of the processing units in processor group 40 include the structures shown in FIG. 4, certain processing units or subsets of the units may be provided with special capabilities as desired, such as additional ports.

With further reference to FIG. 5, the fault isolation circuitry 60 is shown in greater detail. Each processing chip (or more generally, any FRU in the SMP system) has a counter/timer 76 in the fault isolation circuitry. These counters are used to determine which component was the primary source of an error which may have propagated to other “downstream” components of the system and generated secondary errors. As explained in the Background section, prior art fault isolation techniques used a counter that started when an error was detected, and then stopped after the error had traversed the ring topology. The counter with the biggest count then corresponded to the source of the error. In contrast, the present invention starts all of the counters 76 at boot time (or some other common initialization time prior to an error event), and then a given counter is stopped immediately upon detecting an error state. The counter with the lowest count now identifies the component which is the original source of the error.

Counter 76 is frozen or suspended at the first occurrence of an error by a latch 78 which is activated by the error signal. The error signal can either come internally from error correction code (ECC) circuitry, functional control checkers, or parity checking circuitry associated with a core 56a, 56b or memory subsystem 58, or externally from the single-bit error line included in the data pathways. Processor runtime diagnostics code running in the service processor can check counters 76 via the JTAG interface to determine which has the lowest count, corresponding to the earliest moment in time that an error was detected by any fault isolation circuitry 60. The diagnostics code will then log an error event for the corresponding component identified as the primary source. For recoverable errors, the entire process occurs while the processors are still running. This improved failure analysis results in faster repairs and more uptime after fault occurs. A service call need not be made on the first reported error for a given FRU. Error information can be collected by the diagnostics code and, if the number of errors for a particular FRU exceeds an associated threshold, then the service call is made. This approach allows the system to distinguish between an isolated “soft error” event which does not necessarily indicate defective hardware, and a more persistent or “hard error” event that indicates a component has experienced a fault or defect.

The clock (increment) frequency for each counter 76 is the same, but to ensure proper interpretation of the counts, all of the counters must be synchronized. Synchronization can be performed at boot time. In the illustrative embodiment the single-bit error line is utilized for the synchronization signal, but a separate signal could alternatively be provided. In this manner, when the system is first powered on, the error signal can be used to activate synchronization logic 80 which resets counter 76. Synchronization logic 80 takes into account the latency of the error signal for the particular chip, i.e., different counters in different chips may have different initialization values, other than zero, based on the relative delay in receiving the initializing error signal (this latency could alternatively be taken into consideration by the diagnostics code at the other end of the error cycle, with all of the counters reset to a zero value). All counters are cleared and re-synchronized after the diagnostics code has handled the error. Instead of the specialized synchronization hardware 80, the service processor could alternatively be used to synchronize the counters via the JTAG and SCOM interfaces.

Inasmuch as the counters 76 have a limited count value, they operate in a modulo fashion, wrapping the current count around to zero when the counter is incremented from its maximum value. If the maximum count value is relatively low, it might be possible for the diagnostics code to misinterpret the count results, e.g., identifying a zero value in a counter as the lowest count, when in actuality that counter represents a higher count due to the modulo wraparound. To avoid this problem, each counter is provided with sufficient storage to guarantee that the maximum count value corresponds to a cycle time (based on the clock frequency) that is at least two times the maximum error propagation delay around the system, i.e., the most time it would take for an error to traverse processor group 40. The diagnostics code, knowing this, can recognize a low wraparound value by the large difference (in excess of the maximum propagation delay) between it and the highest count found, and simply factor the modulo arithmetic into the wraparound value when identifying the lowest count (e.g., by adding the maximum count value to any wraparound values).

In the case of a hard recoverable fault (e.g., a single “stuck” bit on an ECC protected interface), fault isolation can be even more difficult. In such a case, when the fault isolation registers (FIRs) have been cleared, another error may be in midstream of propagating around the communications topology. If special care is not taken, the FIRs can be cleared and the error reporting will begin anew midstream, resulting in a false identification of an intermediate secondary error as a primary error. This problem may be solved by momentarily quiescing the communications pathways to remove any intermediate traffic, synchronously clearing the FIRs and counters on all chips, and then restarting the communications pathways again. In this manner no intermediate fault propagation can falsely activate the wrong isolation registers. This quiesce time is so small as to not be seen by the processing units or I/O devices as any different from delay due to normal arbitration to use the communication topology, such that the customer sees no outage when the diagnostic code clears the source of a recoverable error.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, the invention has been disclosed in the context of fault isolation circuitry which is associated with processing units, but the invention is more generally applicable to any component of a computer system, particularly any FRU, and not just processing units. It is therefore contemplated that such modifications can be made without departing from the spirit or scope of the present invention as defined in the appended claims.

What is claimed is:

1. A method of identifying a primary source of an error which propagates through a portion of a computer system and generates secondary errors, comprising the steps of:
initializing a plurality of counters that are respectively associated with a plurality of computer components;
incrementing the plurality of counters as the computer components operate;
suspending a given one of the plurality of counters when its associated computer component detects an error; and
after said suspending step, determining which of the plurality of counters contains a lowest count value.

2. The method of claim 1 wherein said initializing step includes the step of synchronizing each of the plurality of counters based on relative delays in receiving an initialization signal.

3. The method of claim 1 wherein one of the plurality of counters is on an integrated circuit chip and is suspended in response to the step of detecting an error in a component that is on the same integrated circuit chip.

4. The method of claim 1 wherein one of the plurality of counters is on a first integrated circuit chip and is suspended in response to the step of detecting an error signal from a second integrated circuit chip.

5. The method of claim 1, further comprising the step of logging an error event for a particular computer component associated with a counter containing the lowest count value, in response to said determining step.

6. The method of claim 1 wherein:
one of the plurality of counters is suspended at a low wraparound value after being incremented one or more times beyond a maximum count value; and
said determining step includes the step of adding the maximum count value to the low wraparound value.

7. The method of claim 1, further comprising steps of:
quiescing communications pathways between the computer components;
after said quiescing step, clearing fault isolation registers on the computer components; and
restarting the communications pathways after said clearing step.

8. A mechanism for identifying a primary source of an error which propagates through a portion of a computer system and generates secondary errors, comprising:
a plurality of counters that are respectively associated with a plurality of computer components, each of said counters being initialized and incrementing as the computer components operate;
means for suspending a given one of said plurality of counters when its associated computer component detects an error; and
means for determining which of said plurality of counters contains a lowest count value.

9. The mechanism of claim 8 wherein said plurality of counters are synchronized based on relative delays in receiving an initialization signal.

10. The mechanism of claim 8 wherein a particular one of said plurality of counters is on an integrated circuit chip, and said suspending means suspends said particular counter in response to detection of an error in a component that is on the same integrated circuit chip.

11. The mechanism of claim 8 wherein a particular one of said plurality of counters is on a first integrated circuit chip, and said suspending means suspends said particular counter in response to detection of an error signal from a second integrated circuit chip.

12. The mechanism of claim 8, further comprising diagnostics code which logs an error event for a particular computer component associated with a counter containing the lowest count value.

13. The mechanism of claim 8 wherein each counter is provided with sufficient storage such that a maximum count value for each counter corresponds to a cycle time that is at least two times a maximum error propagation delay around the computer components.

14. The mechanism of claim 8 wherein said determining means quiesces communications pathways between the computer components and clears fault isolation registers on the computer components while they are quiesced, and then restarts the communications pathways.

15. A computer system comprising:
a plurality of processing units;
a memory hierarchy for supplying program instructions and operand data to said processing units;
data pathways allowing communications between various ones of said plurality of processing units;
a plurality of counters that are respectively associated with said plurality of processing units, each of said counters being initialized and incrementing as said plurality of processing units operate;
fault isolation logic which suspends a given one of said plurality of counters when its associated processing unit detects an error; and
means for determining which of said plurality of counters contains a lowest count value.

16. The computer system of claim 15 wherein said plurality of counters are synchronized based on relative delays in receiving an initialization signal.

17. The computer system of claim 15 wherein a particular one of said plurality of counters is on an integrated circuit chip, and said fault isolation logic suspends said particular counter in response to detection of an error in a processing unit that is on the same integrated circuit chip.

18. The computer system of claim 15 wherein a particular one of said plurality of counters is on a first integrated circuit chip, and said suspending means suspends said particular counter in response to detection of an error signal from a second integrated circuit chip.

19. The computer system of claim 15, further comprising diagnostics code which logs an error event for a particular processing unit associated with a counter containing the lowest count value.

20. The computer system of claim 15 wherein each counter is provided with sufficient storage such that a maximum count value for each counter corresponds to a cycle time that is at least two times a maximum error propagation delay around said processing units.

21. The computer system of claim 15 wherein said determining means quiesces said communications pathways and clears fault isolation registers in said processing units while they are quiesced, and then restarts said communications pathways.
